(19) United States
(12) Patent Application Publication
(10) Pub. No.: US 2025/0068577 A1
(43) Pub. Date: Feb. 27, 2025

(54) SWITCH, MEMORY SHARING METHOD, SYSTEM, COMPUTING DEVICE, AND STORAGE MEDIUM

(71) Applicant: Alibaba Innovation Private Limited, Singapore (SG)

(72) Inventors: Yijin GUAN, Beijing (CN); Dimin NIU, Sunnyvale, CA (US); Tianchan GUAN, Shanghai (CN); Zhaoyang DU, Beijing (CN); Hongzhong ZHENG, Los Gatos, CA (US)

(21) Appl. No.: 18/812,672

(22) Filed: Aug. 22, 2024

(30) Foreign Application Priority Data
Aug. 25, 2023 (CN) 202311082957.0

(51) Int. Cl. G06F 13/40; G06F 13/16; G06F 13/42

(52) U.S. Cl. CPC G06F 13/4022; G06F 13/1652; G06F 13/4221

(57) ABSTRACT

The present invention provides a switch, which is equipped with multiple connection interfaces, for connecting to multiple external processors respectively, enabling mutual access to the respective memories of these processors through the switch. The switch is configured to: through a memory request service component corresponding to a first processor, set within the switch, receive a first memory request sent by the first processor; convert the first memory request into a second memory request aimed at accessing the memory of a second processor and send this second memory request to a memory response service component corresponding to the second processor within the switch; through the memory response service component, convert the second memory request into a third memory request for accessing local memory and send this third memory request to the second processor to access the memory resources corresponding to the second processor.

### CROSS-REFERENCE TO RELATED APPLICATIONS

This application claims priority to Chinese Patent Application No. 202311082957.0, filed with the China National Intellectual Property Administration on Aug. 25, 2023, and entitled “Switch, Memory Sharing Method, System, Computing Device, and Storage Medium,” which is incorporated herein by reference in its entirety.

### TECHNICAL FIELD

The embodiments of the present invention relate to the field of communication technology, particularly to a switch, a memory sharing method, a system, a computing device, and a storage medium.

### BACKGROUND

With the development of computer technology, more and more applications require the support of multiple device nodes. Taking cloud applications as an example, many cloud applications need to be implemented based on multiple device nodes. This is because cloud applications usually have large memory requirements. For existing multiple device nodes, on the one hand, the memory requirements of cloud applications far exceed the memory capacity that a single device node can provide, making it difficult for the memory capacity of a single device node to meet the needs of cloud applications; on the other hand, some device nodes may have idle memory capacity, but the memory capacity in these device nodes consists of fragmented memory, which cannot be consolidated for use by cloud applications in need.

Therefore, how to provide sufficient memory capacity for applications with large memory requirements has become an urgent problem to solve.

### SUMMARY

In view of this, the embodiments of the present invention provide a switch, a memory sharing method, a system, a computing device, and a storage medium to at least partially solve the above-mentioned problems.

According to a first aspect of the embodiments of the present invention, a switch is provided. The switch is equipped with multiple connection interfaces, used to connect to multiple external processors respectively, enabling mutual access to the respective memories of these processors through the switch. The switch is configured to, through a memory request service component corresponding to a first processor, set within the switch, receive a first memory request sent by the first processor; convert the first memory request into a second memory request aimed at accessing the memory of a second processor and send this second memory request to a memory response service component corresponding to the second processor within the switch; and through the memory response service component, convert the second memory request into a third memory request for accessing local memory and send this third memory request to the second processor to access the memory resources corresponding to the second processor.

According to a second aspect of the embodiments of the present invention, a memory sharing method is provided, which is applied to a switch connected to multiple external processors. The method includes: receiving a first memory request sent by a first processor through a memory request service component corresponding to the first processor, which is set within the switch; converting the first memory request into a second memory request aimed at accessing the memory of a second processor and sending this second memory request to a memory response service component corresponding to the second processor within the switch; and through the memory response service component, converting the second memory request into a third memory request for accessing local memory and sending this third memory request to the second processor to access the memory resources corresponding to the second processor.

According to a third aspect of the embodiments of the present invention, a memory sharing system is provided, which includes multiple processors and a switch. The switch is equipped with multiple connection interfaces, used to connect to the multiple processors respectively, enabling mutual access to the respective memories of these processors through the switch. The switch executes the memory sharing method according to the second aspect of the present invention.

According to a fourth aspect of the embodiments of the present invention, a computing device is provided, which includes: a processor, a memory, a communication interface, and a communication bus. The processor, memory, and communication interface communicate with each other via the communication bus. The memory is used to store at least one executable instruction, which enables the processor to execute the memory sharing method according to the second aspect of the present invention.

According to a fifth aspect of the embodiments of the present invention, a computer storage medium is provided, which stores a computer program. When executed by a processor, this program implements the memory sharing method according to the second aspect of the present invention.

According to the embodiments of the present invention, a solution is provided that connects multiple external processors via a switch. Based on memory request service components and memory response service components set within the switch, memory requests (i.e., the first memory request) sent from the first processor are processed to obtain memory requests that can access the memory resources of the second processor (i.e., the third memory request). This enables mutual memory access among multiple processors connected to the switch, logically forming a memory resource pool from the memories corresponding to these processors. As a result, when the memory required by an application (such as memory needed for a cloud application) cannot be satisfied by a single device node, it can access memory resources via the switch through the processors of other device nodes. This process is transparent to the users of the device node that does not meet the memory requirement. Thus, leveraging the memory resources of other device nodes meets the large memory capacity requirements of the application without user awareness, thereby enhancing the user experience. Moreover, in the device nodes corresponding to multiple processors connected to the switch, some device nodes may have a limited amount of free memory, forming memory fragments that are difficult to reuse. The solution provided by the embodiments of the present invention can integrate these memory fragments through the switch to form a memory resource pool for utilization, thereby improving the utilization rate of these fragmented memory resources.

### BRIEF DESCRIPTION OF THE DRAWINGS

In order to more clearly illustrate the technical solutions in the embodiments of the present invention or the prior art, the drawings required for the description of the embodiments or the prior art will be briefly introduced below. It is evident that the drawings described below are merely some embodiments of the present invention, and for those of ordinary skill in the art, other drawings can be obtained based on these drawings.

FIG. 1 is a schematic diagram of an exemplary memory sharing system in a switch application scenario according to one embodiment of the present invention;

FIG. 2 is a schematic diagram of a switch according to one embodiment of the present invention;

FIG. 3 is a schematic diagram of information interaction between a switch and a processor according to one embodiment of the present invention;

FIG. 4 is a schematic diagram of another switch provided by an embodiment of the present invention;

FIG. 5 is a schematic diagram of yet another switch according to one embodiment of the present invention;

FIG. 6 is a flowchart of a memory sharing method according to an embodiment of the present invention.

### DETAIL DESCRIPTION OF THE EMBODIMENTS

To enable those skilled in the art to better understand the technical solutions in the embodiments of the present invention, the technical solutions in the embodiments of the present invention will be clearly and completely described below in conjunction with the accompanying drawings of the embodiments of the present invention. It is evident that the described embodiments are only some of the embodiments of the present invention and not all embodiments. All other embodiments obtained by a person of ordinary skill in the art based on the embodiments of the present invention shall fall within the scope of protection of the embodiments of the present invention.

The embodiments of the present invention will be further described below in conjunction with the accompanying drawings of the embodiments.

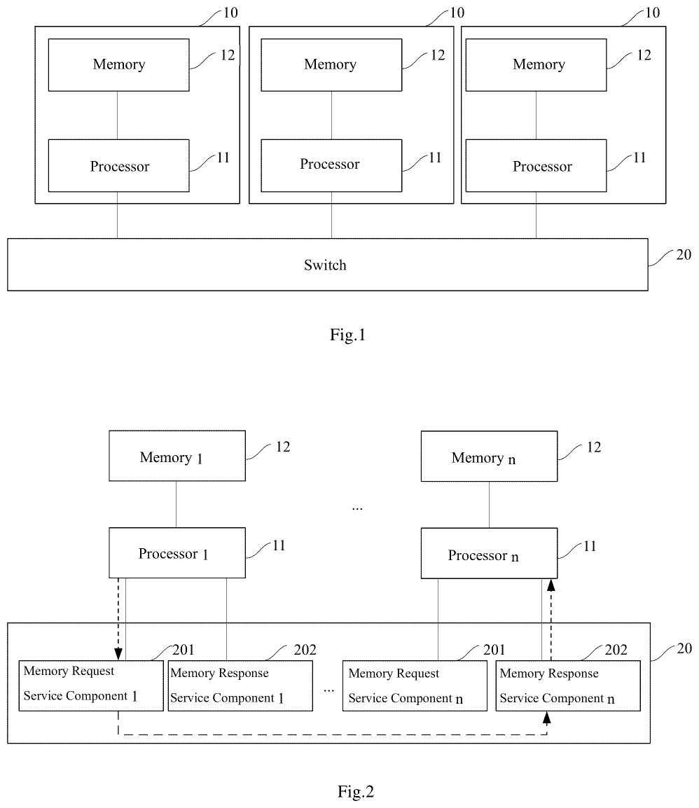

FIG. 1 illustrates an exemplary memory sharing system applicable to a switch according to the embodiments of the present invention. As shown in FIG. 1, the memory sharing system 100 may include hosts 10 and a switch 20. The hosts 10 are physically connected to the switch 20 via multiple interfaces provided on the switch 20. Each host 10 is equipped with a processor 11, and each processor is connected to a corresponding memory 12. When tasks need to be executed, data can be exchanged between different hosts 10 through the switch 20, allowing multiple hosts 10 to work collaboratively.

In some examples, the hosts 10 connected to the switch 20 can perform cloud tasks such as cloud computing tasks, graph computing, and model training tasks, etc. Specifically, the host 10 can execute the tasks it needs to perform through its processor 11. During this process, the processor 11 interacts with the memory 12 in the host.

Due to the typically large memory requirements of cloud applications and cloud computing tasks, the existing multi-device nodes (hosts 10) face several challenges. On one hand, the memory demand of cloud applications far exceeds the memory capacity that a single device node (host 10) can provide, making it difficult for a single device node (host 10) to meet the memory requirements of cloud applications and cloud computing tasks. On the other hand, some device nodes (hosts 10) may have idle memory capacity, but this memory capacity is fragmented and cannot be consolidated for use by demanding cloud applications. As a result, an existing switch 100, which connects multiple hosts 10, cannot utilize these memory fragments and is unable to execute tasks with high memory demands.

Based on the aforementioned memory sharing system, embodiments of the present invention provide a switch, which will be described through multiple embodiments below.

FIG. 2 is a schematic diagram of a switch provided in an embodiment of the present invention. As shown in FIG. 2, the switch 20 is equipped with multiple connection interfaces. These connection interfaces connect to the processor of each device node via their respective connected device nodes, thereby enabling multiple external processors 11 to connect through the multiple connection interfaces of the switch 20. This arrangement allows the multiple processors 11 to access the multiple corresponding memories 12 through the switch 20. It should be noted that in the embodiments of the present invention, unless otherwise specified, terms such as “multiple” or “various” referring to quantities two or more.

The switch 20 can, through a memory request service component 201 configured within the switch 20 and corresponding to a first processor among the multiple processors 11, receive a first memory request sent by the first processor. It then converts this first memory request into a second memory request aimed at accessing the memory of a second processor among the multiple processors 11. The second memory request is then sent to a memory response service component 202 within the switch 20, which corresponds to the second processor. The memory response service component 202 converts the second memory request into a third memory request for accessing a local memory and sends it to the second processor to access memory resources corresponding to the second processor.

The switch 20 connects multiple processors 11 through multiple connection interfaces, with each processor 11 connected to its corresponding memory 12. When executing tasks, the processors 11 can read and write data from their respective connected memory 12 to perform corresponding tasks. When a processor, referred to as the first processor in this embodiment of the invention, needs to execute a task and finds its memory insufficient (e.g., when executing a high-memory task and the required memory exceeds the available memory of the first processor), the first processor sends a first memory request to the memory request service component 201 within the switch 20 that corresponds to the first processor. The switch 20, via the memory request service component 201 configured within it, receives the first memory request from the first processor.

Upon receiving the first memory request, the memory request service component 201 in the switch 20, which corresponds to the first processor, determines that the first processor requires additional memory. At this point, it identifies other processors among the multiple processors 11 that have available memory and determines a second processor that can provide the necessary memory to the first processor. Consequently, since the first memory request needs to be transmitted via a bus of the switch 20, the switch 20 converts the first memory request into a second memory request that can be transmitted through the switch 20's bus. This second memory request is then transmitted to the memory response service component 202, which corresponds to the second processor. Upon receiving the second memory request, the memory response service component 202 converts it into a third memory request that the second processor can process and sends this third memory request to the second processor. Once the second processor receives the third memory request, it allocates available memory resources from its connected memory 12 to the first processor. Logically, this process enables the first processor to utilize memory resources of the second processor.

In the aforementioned process, the protocol used by the first processor to send the first memory request may differ from the bus protocol of the switch 20. Therefore, the memory request service component 201 in the switch 20, which corresponds to the first processor, converts the first memory request sent by the first processor into a second memory request that can be transmitted via the switch 20's bus. This second memory request is then transmitted to the memory response service component 202 corresponding to the second processor. The memory response service component 202 converts the second memory request into a third memory request that can be sent to and directly processed by the second processor. This conversion process enables the first processor to access the memory connected to the second processor.

It should be noted that the multiple processors connected to the switch 20 can form a processor group. Within this processor group, a processor to be assigned a LEADER role can be selected by any suitable method (such as random selection or through an election algorithm). The LEADER processor is responsible for obtaining real-time or periodic information on the available memory of each processor within the group. Consequently, the first processor can send its memory request to the LEADER processor, which will allocate the available memory resources and identify the corresponding processor. Of course, the LEADER processor is also responsible for handling its own memory requests and allocating its own available memory resources. In the embodiments of the present invention, the specific method for allocating the available memory resources is not limited.

It should be understood that when the memory request service component 201 in the switch 20, corresponding to the first processor, receives the first memory request, it can convert the first memory request into multiple second memory requests based on the memory size required by the first memory request and the available memory size of each processor 11. This allows the first memory request to be sent to multiple processors. The multiple memory response service components 202 in the switch 20 can then convert the multiple second memory requests into multiple third memory requests and send these third memory requests to the processors 11 connected to the corresponding memory response service components 202. This enables the first processor to access the memory resources of multiple processors 11. When a processor 11 has a substantial amount of available memory, it can also receive memory requests from multiple processors 11 and provide its connected memory 12 for use by these multiple processors 11.

It should be noted that the functionality of the switch in the embodiments of the present invention can be integrated into existing switches to save on implementation costs. However, this is not the only method; the switch implementing the embodiments of the present invention can also be realized by adding or configuring it in existing systems or platforms, all of which fall within the scope of the present invention. Furthermore, since typically one switch is installed in a cabinet, deploying the embodiments of the present invention at the cabinet level within its internal switch can enable memory resource sharing among multiple device nodes within the cabinet. In this scenario, the number of connection interfaces provided by the switch can be configured to match the number of processors within the cabinet, which can be exemplarily set from 2 to 20 interfaces.

In a specific example, as shown in FIG. 2, suppose processor 1 is performing a cloud computing task such as neural network computation and its corresponding memory 1 is insufficient to support this computation. In this case, processor 1 is considered the first processor. Processor 1 sends a first memory request for 200M of memory resources to the memory request service component 1 in the switch 20 to which it is connected. Upon receiving the first memory request, the memory request service component 1 converts it into a second memory request that can be transmitted via the switch 20's bus. The second memory request is then transmitted through the switch 20's bus to the memory response service component n connected to a second processor (processor n), which has at least 200M of available memory in its corresponding memory n. Upon receiving the second memory request, the memory response service component n converts it into a third memory request that processor n can directly process and sends this third memory request to processor n. Processor n, in response to the third memory request, allocates 200M of its available memory resources to processor 1 for access and use. Consequently, processor 1 can access the memory n connected to processor n.

If processor n can provide 150M of available memory, processor n-1 (not shown in the figure) can provide 30M, and processor n-2 (not shown in the figure) can provide the remaining memory needed, the available memory from processors n, n-1, and n-2 can be consolidated to form a total of 200M of available memory for processor 1's use.

In the embodiments of the present invention, multiple external processors 11 are connected through the switch 20. By utilizing the memory request service component 201 and the memory response service component 202 configured within the switch 20, the memory request (i.e., the first memory request) issued by the first processor is processed to obtain a memory request (i.e., the third memory request) that allows access to the memory resources of the second processor. This setup enables memory inter-access among multiple processors 11 connected to the switch 20, logically forming a memory resource pool composed of the memories 12 corresponding to the multiple processors 11. As a result, on one hand, when the memory required by an application (such as a memory-intensive cloud application) cannot be satisfied by a single device node, the switch 20 allows the processor 11 of other device nodes to access their memory resources. This process is transparent to the user of the device node that lacks sufficient memory, thus meeting the large memory capacity requirements of the application with the help of other device nodes' memory resources. This approach enhances the user experience by ensuring the application runs smoothly without the user noticing any difference. On the other hand, among the device nodes connected to the multiple processors 11 via the switch 20, some device nodes may have minimal available memory, resulting in memory fragments that are difficult to reuse. The embodiments of the present invention enable these memory fragments to be consolidated through the switch 20, forming a memory resource pool that can be utilized effectively. This integration significantly improves the utilization of these fragmented memory resources.

In one possible implementation, the switch solution provided by the embodiments of the present invention can be realized based on the CXL (Compute Express Link) protocol.

CXL is a new open interconnect protocol designed for high-speed cache-coherent interconnections among processors, memory expansion, and accelerators. It includes three sub-protocols: CXL.io, CXL.mem, and CXL.cache. The CXL.io protocol, which is based on PCIe 5.0, serves as an enhanced version of PCIe 5.0 and can be used for initializing processors 11, establishing links, device discovery and enumeration, and register access. The CXL.mem protocol allows the host processor to access the memory of CXL devices using load and store commands. The CXL.cache protocol defines the interaction between the main device node and other device nodes, enabling CXL devices to efficiently cache host memory with very low latency using a request and response mechanism.

Based on this, in the embodiments of the present invention, the switch provides multiple external connection interfaces which are multiple CXL interfaces. Multiple processors 11 are interconnected with the switch 20 through the CXL interfaces, based on the CXL.io protocol. In this case, the switch 20 provided by the embodiments of the present invention can be implemented as a CXL switch 20. The switch 20 can control each processor 11 through the CXL.io protocol and perform non-coherent operations such as register configuration for each processor 11.

The application of the CXL protocol by the switch 20 can ensure the consistency of memory connected to different processors linked to the switch 20, as well as the consistency between the memory connected to the processors and the memory on additional devices. This allows for resource sharing to achieve higher performance, reduces the complexity of the software stack, and lowers the overall system cost.

In this embodiment of the present invention, processors 11 are interconnected with the switch 20 through multiple CXL interfaces based on the CXL.io protocol. This allows the switch 20 to perform non-coherent operations such as register configuration on each processor 11 via the CXL.io protocol. Additionally, the CXL interfaces provide a high transmission rate, enabling rapid data transfer. As a result, the switch 20 can quickly transmit user tasks to processors 11 for execution, improving resource sharing efficiency and providing a foundation for the first processor to access the memory of the second processor.

In a possible implementation, the switch 20, through the memory request service component 201, receives a first memory request sent by the first processor based on the CXL.mem protocol. Through the memory response service component 202, it sends a third memory request to the second processor based on the CXL.cache protocol.

When the memory of the first processor is insufficient, the first processor sends a first memory request to the memory request service component 201 of the switch 20 corresponding to the first processor based on the CXL.mem protocol. The memory request service component 201 of the switch 20, corresponding to the first processor, receives the first memory request, converts it into a second memory request, and sends it to the memory response service component 202 corresponding to the second processor.

After the memory response service component 202 corresponding to the second processor receives the second memory request, it encapsulates it into a third memory request based on the CXL.cache protocol and sends the third memory request to the second processor. This enables the first processor to access the memory of the second processor via the switch.

In an example, FIG. 3 is a schematic diagram illustrating information interaction between a switch and processors according to an embodiment of the present invention. As shown in FIG. 3, processors 1 to n are interconnected with the switch 20 based on the CXL.io protocol of the CXL protocol. Processor 1 is the first processor, and processor n is the second processor. Processor 1 sends a first memory request based on the CXL.mem protocol. After the memory request service component 1 in the switch 20 corresponding to processor 1 receives the first memory request, it converts the first memory request into a second memory request and transmits the second memory request to the memory response service component n connected to processor n. Upon receiving the second memory request, the memory response service component n converts it into a third memory request that complies with the CXL.cache protocol and transmits the third memory request to processor n through CXL.cache. This enables processor 1 to access the memory connected to processor n, achieving memory resource sharing. Between the first memory request and the third memory request, there is a second memory request, as previously described. This second memory request ensures that the requested data can be efficiently transmitted using the switch bus.

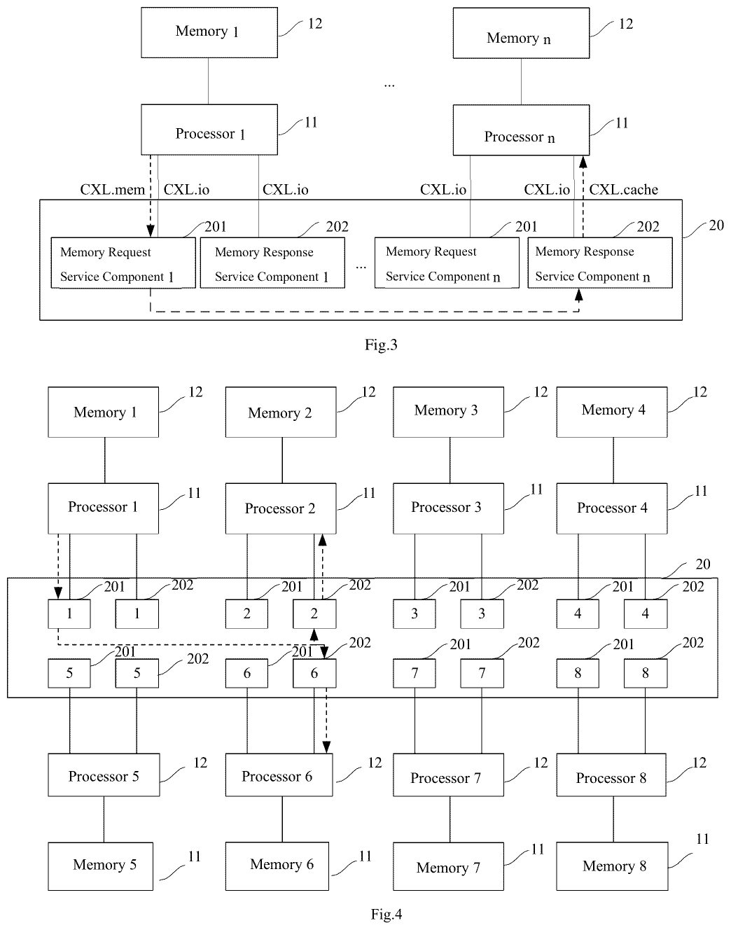

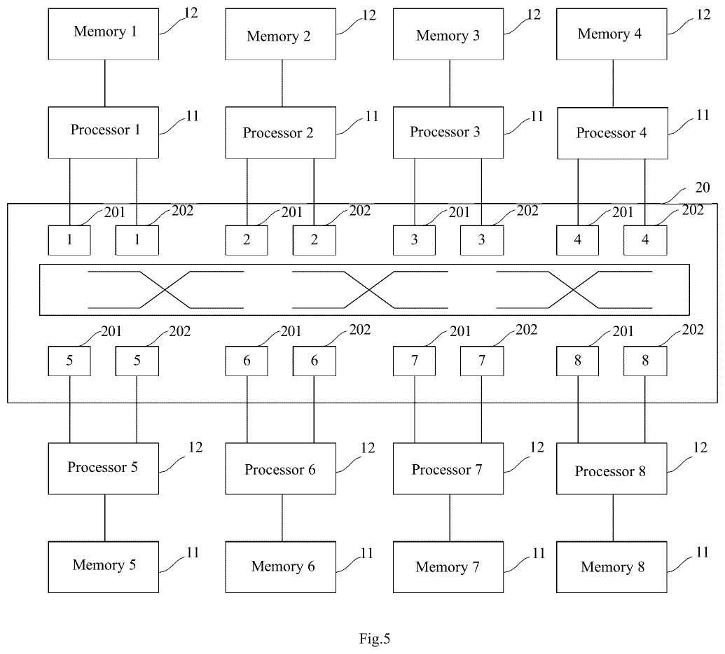

FIG. 4 is a schematic diagram of another switch according to an embodiment of the present invention. As shown in FIG. 4, multiple processors 11 have corresponding pairs of memory request service component 201 and memory response service component 202 in the switch 20. Each pair of components corresponds to a specific processor, with one processor corresponding to one pair of components. Specifically, the memory request service component 201 is used to process memory request applications from the corresponding processor 11, while the memory response service component 202 is used to respond to memory request applications to provide memory resources to the processor 11 that sent the memory request.

Multiple processors 11 are respectively connected to multiple memory units 12. These processors correspond to pairs of components in multiple switches 20, where each pair includes a memory request service component 201 and a memory response service component 202. When a processor 11 sends a memory request to the memory request service component 201, the memory response service component 202 corresponding to this processor 11 will not receive memory request applications sent by the switch 20. In other words, when one processor 11 requests memory, it will not receive memory requests from other processors 11. During a single memory handling process, a processor will not simultaneously act as both the requester and the responder.

In an example, as shown in FIG. 4, processor 1 acts as the first processor requiring memory. Suppose it is determined that processors 2 and 6 can provide the memory needed by the first processor. Processor 1 sends a first memory request to the memory request service component 1 in switch 20, corresponding to processor 1. After receiving the first memory request, the memory request service component 1 converts it into two corresponding second memory requests and sends these second memory requests to the memory response service components 2 and 6 corresponding to processors 2 and 6, respectively. Upon receiving their respective second memory requests, memory response service components 2 and 6 convert these requests into third memory requests that can be processed by processors 2 and 6, respectively. These third memory requests are then transmitted to processors 2 and 6. This process enables processor 1 to access the memory associated with processors 2 and 6.

It should be noted that the above example is provided merely for illustrative purposes. The processor with the LEADER role in the processor group can determine whether to send the second memory request to a single processor 11 or to multiple processors 11 based on the required memory size of processor 11 and the available free memory size of each processor 11. This aspect of the invention is not limited to the specific example provided.

In the embodiments of the present invention, different processors 11 have corresponding pairs of memory request service component 201 and memory response service component 202. This configuration enables independent request processing between different processors 11, thereby efficiently achieving memory resource sharing.

In a possible implementation, the pairs of memory request service component 201 and memory response service component 202 are configured as Consumer-Provider component pairs.

In the embodiments of the present invention, the memory request service component 201 functions as a Consumer component, while the memory response service component 202 acts as a Provider component. The Consumer component of the first processor can send consumer requests, i.e., memory request applications, to the Provider components connected to other processors. Similarly, the Provider component of the first processor can receive consumer requests sent by the Consumer components connected to other processors and provide resources in response to these requests, i.e., receive memory request applications. Thus, the first processor can access the memory resources of other processors through its Consumer component, and allow other processors to access its memory resources through its Provider component, thereby achieving memory resource sharing. By using the Consumer-Provider component pairs, the processing of memory requests and responses can be efficiently managed. Each processor having its own Consumer-Provider component pair also ensures more organized and efficient management of memory sharing, with low implementation costs.

In the embodiments of the present invention, the memory request service component 201 functions as a Consumer component, and the memory response service component 202 functions as a Provider component. The Consumer component can send a second memory request to the second processor, and the Provider component can receive second memory requests sent by other processors. This configuration enables memory resource sharing among processors 11 connected to the switch 20, improving the utilization of fragmented memory resources and enhancing the transmission efficiency of memory request applications.

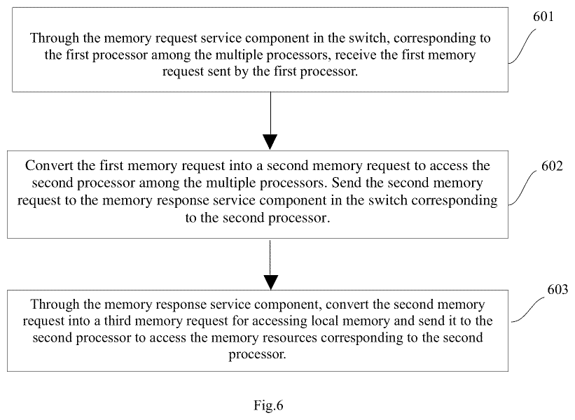

FIG. 5 is a schematic diagram of yet another switch according to an embodiment of the present invention. As shown in FIG. 5, based on the switch 20 illustrated in FIG. 4, multiple pairs of memory request service component 201 and memory response service component 202 are interconnected through a crossbar switch matrix.

In the embodiments of the present invention, the switch 20 includes multiple pairs of memory request service component 201 and memory response service component 202. These pairs of components are interconnected through a crossbar switch matrix, such as a Crossbar.

In the embodiments of the present invention, multiple pairs of memory request service component 201 and memory response service component 202 are interconnected through a crossbar switch matrix. This interconnection enables a memory request service component 201 to send a memory request application to one or more memory response service components 202 connected to other processors. This setup can increase the transmission speed of the second memory request, reduce the latency for processors 11 to access the memory of other processors 11, and make the process seamless for users. As a result, it enhances the user experience and improves the task processing efficiency of the processors 11.

In a possible implementation, the memory request service component 201 is also equipped with an interface for connecting to an accelerator.

In an example, each memory request service component 201 corresponding to a processor is also provided with an accelerator connection interface to connect to an accelerator with required functionalities. This accelerator can preprocess the data to be sent to the processor, thereby reducing the data processing burden on the processor and enhancing data processing speed and efficiency.

In a possible implementation, the accelerator can be an accelerator for near-memory computing.

The accelerator interface provided in the memory request service component 201 can connect to a near-memory computing accelerator.

Memory architecture typically consists of multiple levels of cache, main memory, and storage. The traditional data processing method involves moving data from storage to cache before processing it. Near Memory Computing (NMC), however, processes data close to where it is stored. This data-centric approach couples computation units near the data to minimize data movement and prevent data loss.

In the embodiments of the present invention, the memory request service component 201 is also provided with an interface for connecting a near-memory computing accelerator. This allows the near-memory computing accelerator to be connected to the memory request service component 201 in the switch 20, thereby improving the efficiency of processor 11 in handling tasks and utilizing memory.

In a possible implementation, the switch 20 can convert the first memory request into a second memory request that carries the address information of the memory resources to be accessed in the second processor and conforms to the bus protocol of the switch 20. This second memory request is then sent through the bus within the switch 20 to the memory response service component 202 corresponding to the second processor.

In an example, the first processor sends a first memory request to the LEADER processor in the processor group. After receiving the request, the LEADER processor searches for and allocates a second processor (which can be one or multiple processors) that can provide available memory for the request and confirms the memory address of the second processor. The switch 20 then converts the first memory request into a second memory request that carries the memory address information corresponding to the second processor and conforms to the bus protocol of the switch 20.

Since the second memory request complies with the bus protocol of the switch 20, it can be transmitted through the bus of switch 20, along with the address information in the second memory request, to the memory response service component 202 corresponding to the second processor. Upon receiving the second memory request, the memory response service component 202 of the second processor converts it into a third memory request. This allows the first processor to access the memory 12 connected to the second processor when its own memory is insufficient.

It should be understood that since there may be multiple second processors, the second memory request may include multiple requests. These multiple second memory requests can be transmitted through the bus in switch 20 to the memory response service components 202 corresponding to the multiple second processors. This process will not be elaborated further.

In an embodiment of the present invention, the switch 20 can convert the first memory request into a second memory request that includes the address information corresponding to the memory 12 of the second processor. This allows the second memory request to be transmitted to the memory response service component 202 corresponding to the identified second processor, enabling the first processor to access the memory 12 of the second processor. The second memory request complies with the bus protocol of the switch 20, allowing it to be transmitted through the bus of switch 20. This increases the transmission speed, enhances the utilization of fragmented memory resources, and improves the transmission efficiency of memory request applications.

In a possible implementation, the switch 20, based on the address information of the memory resources of the second processor to be accessed, remaps the original memory address information carried in the first memory request to the address information of the memory resources. The remapped first memory request is then converted into a second memory request that conforms to the bus protocol of the switch 20.

The switch 20, through the memory request service component 201 connected to the first processor, remaps the address of the first processor in the first memory request to the address information of the memory resources of the second processor. According to its own bus protocol standards, the switch 20 then converts the remapped first memory request into a second memory request that conforms to the bus protocol of the switch 20. This allows the second memory request to be transmitted through the bus.

Based on the aforementioned switch structure, the following describes a memory sharing method based on this switch through an embodiment.

FIG. 6 is a flowchart of a memory sharing method according to an embodiment of the present invention. This method is applied to a switch connected to multiple external processors. As shown in FIG. 6, the memory sharing method includes the following steps 601 to 603:

Step 601, through the memory request service component in the switch corresponding to the first processor among the multiple processors, receive the first memory request sent by the first processor.

The first processor is a processor in the switch with insufficient memory. When the first processor's memory is insufficient, it sends a first memory request to the switch. The memory request service component in the switch corresponding to the first processor receives the first memory request sent by the first processor.

Step 602, convert the first memory request into a second memory request to access the second processor among the multiple processors. Send the second memory request to the memory response service component in the switch corresponding to the second processor.

The second processor is a processor that can provide available memory. The switch converts the first memory request sent by the first processor into a second memory request. This conversion allows the second memory request to be transmitted through the switch's bus. The switch then sends the second memory request through its bus to the memory response service component corresponding to the second processor.

Step 603, through the memory response service component, convert the second memory request into a third memory request for accessing local memory and send it to the second processor to access the memory resources corresponding to the second processor.

After the memory response service component corresponding to the second processor in the switch receives the second memory request, it converts the second memory request into a third memory request that can be directly processed by the second processor. This third memory request is then sent to the second processor. Upon receiving the third memory request, the second processor makes its connected memory available for access by the first processor, allowing the first processor to access the memory connected to the second processor.

It should be noted that this method can be executed by any processor connected to the switch as specified by the user. Alternatively, a LEADER processor can be selected from among the multiple processors connected to the switch using a random selection algorithm or an election algorithm. The processor executing this method can simultaneously perform computation tasks; this aspect of the invention is not limited.

In the embodiments of the present invention, the memory request service component and the memory response service component set in the switch corresponding to the processors handle the memory request sent by the first processor (i.e., the first memory request) to obtain a memory request that can access the memory resources of the second processor (i.e., the third memory request). This enables memory inter-access among multiple processors connected to the switch, logically forming a memory resource pool composed of the memories corresponding to multiple processors. Thus, on one hand, when the memory required by an application (such as a cloud application) cannot be satisfied by a single device node, the switch can be controlled to access the memory resources of other device nodes' processors. This process is transparent to the user of the device node with insufficient memory, thereby meeting the application's large memory capacity requirements with the help of other device nodes' memory resources. This enhances the user experience by making the process seamless for the application's user. On the other hand, among the device nodes corresponding to the multiple processors connected to the switch, some device nodes may have a small amount of idle memory capacity, forming memory fragments that are difficult to reuse. However, by using the method of the present invention, these memory fragments can be consolidated through the switch into a memory resource pool for utilization, thereby improving the utilization of these memory fragment resources.

In a possible implementation, the switch applying this memory sharing method connects multiple processors through multiple Compute Express Link (CXL) interfaces. The switch receives the first memory request sent by the first processor based on the CXL.mem protocol through the memory request service component. It then sends the third memory request to the second processor based on the CXL.cache protocol through the memory response service component.

In an example, as shown in FIG. 3, processors 1 to n are interconnected with switch 20 based on the CXL.io protocol of the CXL protocol. Processor 1 acts as the first processor, and processor n acts as the second processor. Processor 1 sends a first memory request based on the CXL.mem protocol. Upon receiving the first memory request, the memory request service component 1 in switch 20 corresponding to processor 1 converts it into a second memory request. This second memory request is then transmitted to the memory response service component n connected to processor n. After receiving the second memory request, memory response service component n converts it into a third memory request that complies with the CXL.cache protocol and transmits the third memory request to processor n via CXL.cache. This process enables processor 1 to access the memory n connected to processor n, thereby achieving memory resource sharing.

In the embodiments of the present invention, the switch receives the first memory request sent by the first processor based on the CXL.mem protocol and sends the third memory request to the second processor based on the CXL.cache protocol. This enables the first processor to access the memory of the second processor, allowing the first processor to utilize a larger memory pool. Additionally, it consolidates fragmented memory from multiple processors, enabling the execution of tasks that require large memory. This approach improves the utilization of fragmented memory resources.

In a possible implementation, the switch applying this memory sharing method is equipped with multiple pairs of memory request service component and memory response service component corresponding to multiple processors. The memory request service component processes the memory request applications from its corresponding processor, while the memory response service component responds to these memory requests to provide memory resources to the processor that sent the memory request.

In an example, as shown in FIG. 4, each processor 11 is connected to a corresponding pair of memory request service component 201 and memory response service component 202. When processor 1, acting as the first processor, requires memory, it sends a first memory request to the memory request service component 1 in switch 20 corresponding to processor 1. After receiving the first memory request, the memory request service component 1 converts it into a second memory request. The second memory request is then sent to the memory response service components 2 and 6 corresponding to processor 2 and processor 6, respectively. Upon receiving the second memory request, memory response service components 2 and 6 convert the second memory request into third memory requests, which are then sent to processors 2 and 6, respectively. This enables processor 1 to access the memory corresponding to processors 2 and 6.

In the embodiments of the present invention, the multiple processors connected to the switch each have corresponding pairs of memory request service component and memory response service component in the switch. This configuration enables the independent processing of requests between different processors.

In a possible implementation, the multiple pairs of memory request service component and memory response service component applying this memory sharing method are interconnected through a crossbar switch matrix.

In the embodiments of the present invention, the switch includes multiple pairs of memory request service component and memory response service component. These pairs of components are interconnected through a crossbar switch matrix.

In an example, when applying the memory sharing method in the switch as shown in FIG. 5, the crossbar switch matrix can transmit the second memory request sent by any memory request service component 201 connected to a processor to one or more memory response service components 202 connected to other processors. This setup enables memory resource sharing and interconnection between the component pairs.

In the embodiments of the present invention, multiple pairs of memory request service component 201 and memory response service component 202 are interconnected through a crossbar switch matrix. This interconnection allows a memory request service component 201 to send a memory request to one or more memory response service components 202 connected to other processors. This setup increases the transmission speed of the second memory request, reduces the latency for processor 11 when accessing the memory of other processors 11, and makes the process seamless for the user. Consequently, it enhances the user experience and improves the task processing efficiency of processor 11.

Additionally, it should be noted that any user-related information (including but not limited to user device information, personal information, etc.) and data (including but not limited to cloud task data processed by the processor, stored data, displayed data, etc.) involved in the embodiments of the present invention are authorized by the user or fully authorized by all parties. The collection, use, and processing of such data must comply with the relevant laws, regulations, and standards of the respective countries and regions. Furthermore, appropriate mechanisms are provided to allow users to choose to authorize or deny the use of their information and data.

It should be noted that, as needed for implementation, the various components/steps described in the embodiments of the present invention can be split into more components/steps. Additionally, two or more components/steps, or parts of the operations of the components/steps, can be combined into new components/steps to achieve the objectives of the embodiments of the present invention.

In another example, one embodiment of the present invention also provides a memory sharing system, which includes: multiple processors and a switch. The switch is equipped with multiple connection interfaces, which are used to connect multiple processors respectively, enabling inter-access among the memories corresponding to multiple processors through the switch. It should be understood that the memory sharing system can be the memory sharing system shown in the above figures. The switch can execute the memory sharing method illustrated in FIG. 6.

In another example, an embodiment of the present invention also provides a computing device, which includes: a processor, a memory, a communication interface, and a communication bus. The processor, memory, and communication interface communicate with each other via the communication bus. The memory is used to store at least one executable instruction that enables the processor to execute the memory sharing method illustrated in FIG. 6.

In another example, an embodiment of the present invention also provides a computer storage medium on which a computer program is stored. When executed by a processor, this program implements the memory sharing method illustrated in FIG. 6.

The methods according to the embodiments of the present invention can be implemented in hardware, firmware, or as software or computer code stored on a recording medium (such as CD-ROM, RAM, floppy disk, hard disk, or magneto-optical disk). Alternatively, they can be realized as computer code initially stored in remote recording media or non-transitory machine-readable media and downloaded over a network to be stored in local recording media. Thus, the described methods can be stored on such recording media using general-purpose computers, dedicated processors, or programmable or dedicated hardware (such as Application Specific Integrated Circuits (ASICs) or Field Programmable Gate Arrays (FPGAs)). It is understood that a computer, processor, microprocessor controller, or programmable hardware includes storage components (such as Random Access Memory (RAM), Read-Only Memory (ROM), flash memory, etc.) that can store or receive software or computer code. When this software or computer code is accessed and executed by the computer, processor, or hardware, it implements the methods described herein. Furthermore, when a general-purpose computer accesses code designed to implement the methods shown here, the execution of the code transforms the general-purpose computer into a specialized computer for executing the methods illustrated.

It will be appreciated by those skilled in the art that the units and method steps of the various examples described in connection with the embodiments disclosed herein can be implemented in electronic hardware, or a combination of computer software and electronic hardware. Whether these functions are executed as hardware or software depends on the specific application and design constraints of the technical solution. Skilled professionals may use different methods to implement the described functions for specific applications, but such implementations should not be considered as going beyond the scope of the embodiments of the present invention.

The above embodiments are merely illustrative of the embodiments of the present invention and are not intended to limit the scope of the invention. Those skilled in the relevant technical field can make various changes and modifications without departing from the spirit and scope of the embodiments of the present invention. Therefore, all equivalent technical solutions should also be considered within the scope of the embodiments of the present invention. The scope of patent protection for the embodiments of the present invention should be defined by the claims.

What is claimed is:

1. A switch, the switch comprising:
a plurality of connection interfaces, the plurality of connection interfaces being configured to connect to a plurality of external processors respectively, to enable mutual access to a plurality of memories corresponding to the plurality of processors through the switch, the switch being configured to: receive a first memory request from a first processor of the plurality of processors, through a memory request service component corresponding to the first processor, wherein the memory request service component is within the switch; convert the first memory request into a second memory request to access a second memory of a second processor of the plurality of processors, and send the second memory request to a memory response service component corresponding to the second processor, wherein the memory response service component is within the switch; convert the second memory request into a third memory request to access local memory, through the memory response service component, and send the third memory request to the second processor to access memory resources corresponding to the second processor.

2. The switch according to claim 1, wherein the plurality of connection interfaces are a plurality of Compute Express Link (CXL) interfaces; and wherein the plurality of processors are interconnected with the switch via the CXL interfaces based on a CXL.io protocol.

3. The switch according to claim 2, wherein the switch is configured to: receive the first memory request from the first processor based on a CXL.mem protocol through the memory request service component; and send the third memory request to the second processor based on a CXL.cache protocol through the memory response service component.

4. The switch according to claim 1, wherein the plurality of processors each have a corresponding pair of memory request service component and memory response service component; wherein the memory request service component is configured to process memory requests from the corresponding processor, and the memory response service component is configured to respond to the memory requests to provide memory resources to the processor that sent the memory requests.

5. The switch according to claim 4, wherein the pair of memory request service component and memory response service component is a Consumer-Provider component pair.

6. The switch according to claim 4, wherein the plurality of pairs of memory request service component and memory response service component are interconnected through a crossbar switch matrix.

7. The switch according to claim 4, wherein each of the memory request service components further comprises an interface for connecting an accelerator.

8. The switch according to claim 7, wherein the accelerator is an accelerator for near-memory computing.

9. The switch according to claim 1, wherein the switch, based on address information of the memory resources of the second processor to be accessed, converts the first memory request into a second memory request carrying the address information and conforming to a bus protocol of the switch, and sends the second memory request to the memory response service component corresponding to the second processor through the bus within the switch.

10. The switch according to claim 9, wherein the switch, based on the address information of the memory resources of the second processor to be accessed, remaps original memory address information carried in the first memory request to the address information of the memory resources, and converts the remapped first memory request into the second memory request conforming to the bus protocol of the switch.

11. A method of memory sharing, applied to a switch connected to a plurality of external processors, the method comprising:
receiving, through a memory request service component corresponding to a first processor of the plurality of processors within the switch, a first memory request sent by the first processor;
converting the first memory request into a second memory request to access a second processor of the plurality of processors, and sending the second memory request to a memory response service component corresponding to the second processor within the switch;
converting, through the memory response service component, the second memory request into a third memory request for accessing local memory; and
sending the third memory request to the second processor to access memory resources corresponding to the second processor.

12. The method according to claim 11, wherein the switch connects the plurality of processors through a plurality of Compute Express Link (CXL) interfaces; wherein the switch receives the first memory request sent by the first processor based on a CXL.mem protocol through the memory request service component; and wherein the switch sends the third memory request to the second processor based on a CXL.cache protocol through the memory response service component.

13. The method according to claim 11, wherein the switch is configured with a plurality of pairs of memory request service component and memory response service component corresponding to the plurality of processors; wherein the memory request service component is configured to process memory requests from the corresponding processor, and the memory response service component is configured to respond to the memory requests to provide memory resources to the processor that sent the memory requests.

14. The method according to claim 11, wherein the plurality of pairs of memory request service component and memory response service component are interconnected through a crossbar switch matrix.

15. A memory sharing system, comprising:
a plurality of processors each having a memory associated with the processor;
a switch configured with a plurality of connection interfaces, the plurality of connection interfaces being configured to connect to the plurality of processors respectively, to enable mutual access to the memories corresponding to the plurality of processors through the switch, the switch further comprising a plurality pairs of memory request service component and memory response service component, each pair corresponding to a processor of the plurality of processors,
wherein the switch is configured to: receive a first memory request from a first processor of the plurality of processors, through a memory request service component corresponding to the first processor, convert the first memory request into a second memory request to access a second memory corresponding to a second processor of the plurality of processors, and send the second memory request to a memory response service component corresponding to the second processor, convert the second memory request into a third memory request, through the memory response service component, and send the third memory request to the second processor to access the second memory corresponding to the second processor.

16. The memory sharing system according to claim 15, wherein the plurality of connection interfaces are a plurality of Compute Express Link (CXL) interfaces; and
wherein the plurality of processors are interconnected with the switch via the CXL interfaces based on a CXL.io protocol.

17. The memory sharing system according to claim 16, wherein the switch is configured to: receive the first memory request from the first processor based on a CXL.mem protocol; and send the third memory request to the second processor based on a CXL.cache protocol.

18. The memory sharing system according to claim 15, wherein the plurality of pairs of memory request service component and memory response service component are interconnected through a crossbar switch matrix.

19. The memory sharing system according to claim 15, wherein each of the memory request service components further comprises an interface for connecting an accelerator.

20. The memory sharing system according to claim 19, wherein the accelerator is an accelerator for near-memory computing.
